(19) United States
(12) Patent Application Publication
(10) Pub. No.: US 2006/0261191 A1
(43) Pub. Date: Nov. 23, 2006

(54) Shower head assembly

(76) Inventor: Tsung-Chieh Chang, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/119,586

(22) Filed: May 2, 2005

(51) Int. Cl. B05B 9/01; B05B 7/02

(52) U.S. Cl. 239/525; 239/526

(57) ABSTRACT

A shower head assembly includes a handle, and a mode control device mounted on the handle to control the water injection modes of the shower head assembly. Thus, the shower head assembly forms an inner water injection effect, an outer water injection effect and a combined water injection effect so that the shower head assembly has different water injection modes so as to satisfy the requirements of different users.

### BACKGROUND OF THE INVENTION

1. Field of the Invention

The present invention relates to a shower head assembly, and more particularly to a shower head assembly having different adjustable water injection modes.

2. Description of the Related Art

A conventional shower head comprises a handle, and a faceplate secured on an end face of the handle to inject the water outward from the handle. However, the handle has a smooth surface so that the user's one hand cannot hold the handle closely and easily slips from the handle when the handle is wet, thereby causing inconvenience to the user. In addition, the conventional shower head only has a single water injection mode so that the shower head cannot satisfy the requirements of different users actually, thereby limiting the versatility the shower head.

### SUMMARY OF THE INVENTION

The primary objective of the present invention is to provide a shower head assembly having different adjustable water injection modes.

Another objective of the present invention is to provide a shower head assembly that forms an inner water injection effect, an outer water injection effect and a combined water injection effect so that the shower head assembly has different water injection modes so as to satisfy the requirements of different users.

A further objective of the present invention is to provide a shower head assembly, wherein the catch portion of one of the blades of the rotation member produces a water catch effect to each of the oblique guide slots of the inner guide member during rotation of the rotation member so that each of the oblique guide slots of the inner guide member produces an intermittent water injection action to provide a massaging effect to a user.

A further objective of the present invention is to provide a shower head assembly, wherein the handle has an anti-slip effect so as to facilitate a user holding the handle.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a shower head assembly in accordance with the preferred embodiment of the present invention;

FIG. 2 is an exploded perspective view of the shower head assembly as shown in FIG. 1;

FIG. 3 is a side plan cross-sectional view of the shower head assembly as shown in FIG. 1;

FIG. 4 is a top plan cross-sectional view of the shower head assembly as shown in FIG. 1;

FIG. 5 is a front plan cross-sectional view of the shower head assembly as shown in FIG. 1;

FIG. 6 is a schematic operational view of the shower head assembly as shown in FIG. 5; and

FIG. 7 is a schematic operational view of the shower head assembly as shown in FIG. 5.

### DETAILED DESCRIPTION OF THE INVENTION

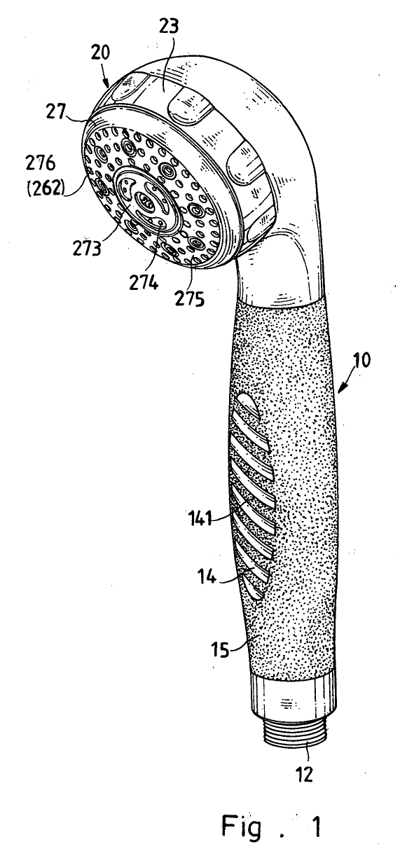

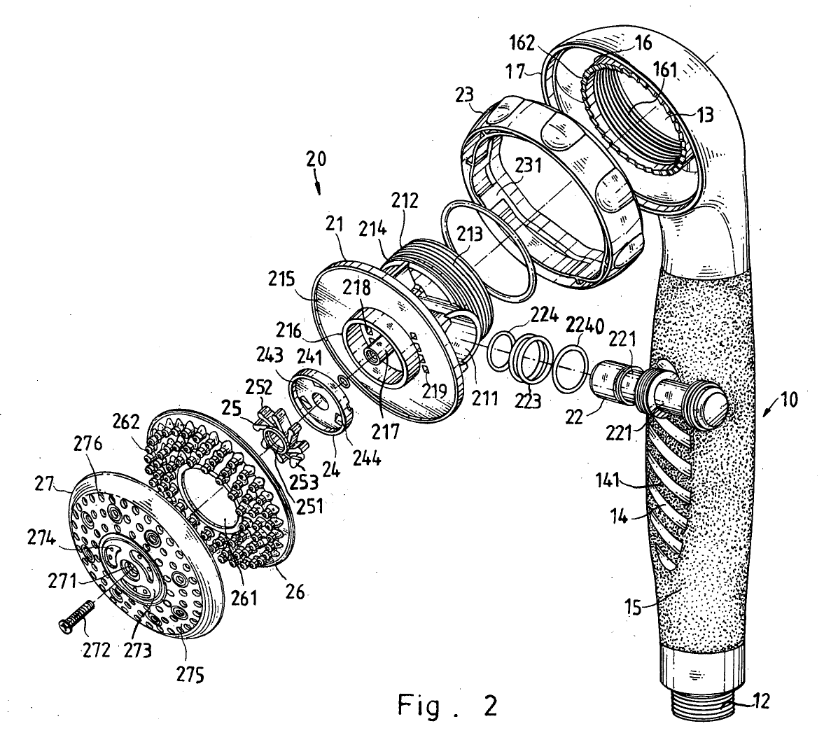

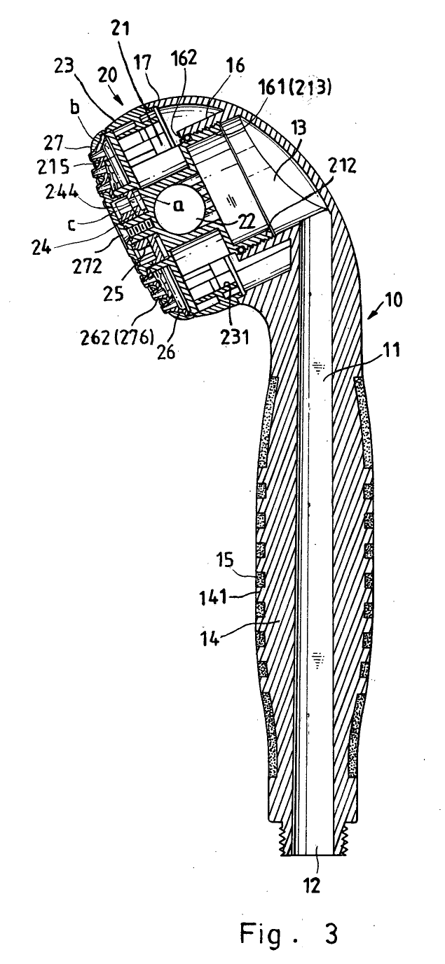

Referring to the drawings and initially to FIGS. 1-5, a shower head assembly in accordance with the preferred embodiment of the present invention comprises a handle 10, and a mode control device 20 mounted on the handle 10 to control the water injection modes of the shower head assembly.

The handle 10 has an inside formed with a flow channel 11 having a first end formed with a water inlet 12 and a second end formed with a water outlet 13. The water outlet 13 of the handle 10 has an inner peripheral wall 16 having an inner face formed with an inner thread 161 and an end face formed with a plurality of ratchet teeth 162 and an outer peripheral wall 17 separated from the inner peripheral wall 16. The handle 10 has a hard body 14 made of plastic material integrally formed by an injection molding process, and a soft coating layer 15 integrally coated on the hard body 14 and having a thickness of about 1.5 to 4.5 mm so that the handle 10 has an anti-slip effect. The hard body 14 has a surface formed with a plurality of hard layers 141 protruded from the soft coating layer 15 to enhance the outer appearance of the handle 10 and arranged in a staggered manner to facilitate a user holding the handle 10. Each of the hard layers 141 the hard body 14 has a thickness equal to that of the soft coating layer 15.

The mode control device 20 includes a valve seat 21, a valve shaft 22, an adjusting ring 23, an inner guide member 24, a rotation member 25, an outer guide member 26, and a cover 27.

The valve seat 21 has a mediate portion formed with a valve chamber 211 connected to the water outlet 13 of the handle 10. The valve seat 21 has a first end provided with a sealing disk 215 having a side formed with an annular wall 216, a plurality of inner water outlet holes 218 located inside of the annular wall 216 and connected to the valve chamber 211 and a plurality of outer water outlet holes 219 located outside of the annular wall 216 and connected to the valve chamber 211. The sealing disk 215 of the valve seat 21 has a central portion provided with a threaded post 217. The valve seat 21 has a second end provided with a connector 212 mounted in the inner peripheral wall 16 of the water outlet 13 of the handle 10 and connected to the valve chamber 211. The connector 212 of the valve seat 21 has an outer wall engaged with the ratchet teeth 162 of the water outlet 13 of the handle 10 and formed with an outer thread 213 screwed into the inner thread 161 of the water outlet 13 of the handle 10. An O-ring 214 is mounted between the connector 212 of the valve seat 21 and the inner peripheral wall 16 of the water outlet 13 of the handle 10.

The valve shaft 22 is movably mounted in the valve chamber 211 of the valve seat 21 and has two distal ends each protruding outward from the valve seat 21. The valve shaft 22 has a mediate portion formed with two spaced annular grooves 221 which define two water chambers 222 between the valve shaft 22 and the valve chamber 211 of the valve seat 21. The mediate portion of the valve shaft 22 is provided with at least one sealing ring 223 to separate and seal the two water chambers 222. The mode control device 20 further includes a first stop ring 224 mounted on the valve shaft 22 to move therewith and movable to seal the inner water outlet holes 218 of the valve seat 21 to close a connection between the inner water outlet holes 218 of the valve seat 21 and the water chambers 222 of the valve shaft 22, and a second stop ring 2240 mounted on the valve shaft 22 to move therewith and movable to seal the outer water outlet holes 219 of the valve seat 21 to close a connection between the outer water outlet holes 219 of the valve seat 21 and the water chambers 222 of the valve shaft 22.

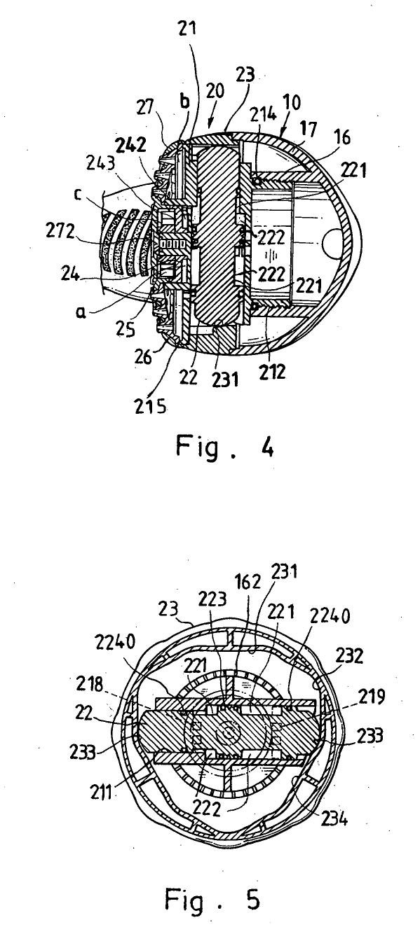

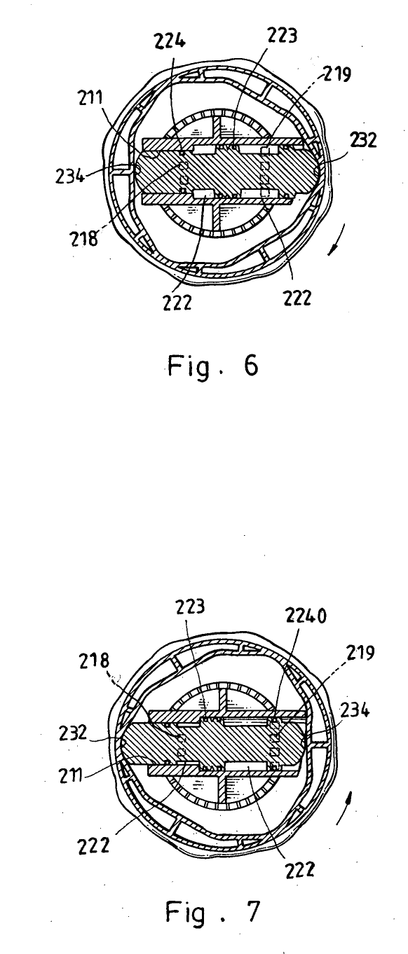

The adjusting ring 23 is rotatably mounted on the valve seat 21 and located between the outer peripheral wall 17 of the water outlet 13 of the handle 10 and the sealing disk 215 of the valve seat 21. The adjusting ring 23 has an inner wall formed with a cam portion 231 rested on the two distal ends of the valve shaft 22 to move the valve shaft 22 in the valve chamber 211 of the valve seat 21 by rotation of the adjusting ring 23. The cam portion 231 of the adjusting ring 23 has a plurality of first positioning points 232, second positioning points 233 and third positioning points 234 arranged in a staggered manner, wherein any two of the second positioning points 233 are located opposite to each other as shown in FIG. 5 to press the two distal ends of the valve shaft 22, and each of the first positioning points 232 is located opposite to a respective one of the third positioning points 234 as shown in FIGS. 6 and 7 to press the two distal ends of the valve shaft 22. Preferably, the cam portion 231 of the adjusting ring 23 has twelve positioning points including three first positioning points 232, six second positioning points 233 and three third positioning points 234.

Thus, when the two distal ends of the valve shaft 22 are rested on two opposite second positioning points 233 of the adjusting ring 23 respectively as shown in FIG. 5, the sealing ring 223 of the valve shaft 22 is located at the middle position of the valve chamber 211 of the valve seat 21 and the inner water outlet holes 218 and the outer water outlet holes 219 of the valve seat 21 are connected to the water chambers 222 of the valve shaft 22 respectively.

Alternatively, when a first distal end of the valve shaft 22 is rested on one of the first positioning points 232 of the adjusting ring 23 and a second distal end of the valve shaft 22 is rested on the respective opposite third positioning point 234 of the adjusting ring 23 as shown in FIG. 6, the sealing ring 223 of the valve shaft 22 is displaced rightward, the outer water outlet holes 219 of the valve seat 21 are connected to the water chambers 222 of the valve shaft 22, and the inner water outlet holes 218 of the valve seat 21 are sealed by the first stop ring 224, thereby interrupting the connection between the inner water outlet holes 218 of the valve seat 21 and the water chambers 222 of the valve shaft 22.

Alternatively, when the first distal end of the valve shaft 22 is rested on one of the third positioning points 234 of the adjusting ring 23 and the second distal end of the valve shaft 22 is rested on the respective opposite first positioning point 232 of the adjusting ring 23 as shown in FIG. 7, the sealing ring 223 of the valve shaft 22 is displaced leftward, the inner water outlet holes 218 of the valve seat 21 are connected to the water chambers 222 of the valve shaft 22, and the outer water outlet holes 219 of the valve seat 21 are sealed by the second stop ring 2240, thereby interrupting the connection between the outer water outlet holes 219 of the valve seat 21 and the water chambers 222 of the valve shaft 22.

The cover 27 is mounted on the sealing disk 215 of the valve seat 21. The cover 27 has an inner water outlet zone 273 formed with a plurality of inner water injection holes 274 connected to the inner water outlet holes 218 of the valve seat 21 and an outer water outlet zone 275 formed with a plurality of outer water injection holes 276 connected to the outer water outlet holes 219 of the valve seat 21. The cover 27 has a central portion formed with a through hole 271. A locking bolt 272 is extended through the through hole 271 of the cover 27 and screwed into the threaded post 217 of the valve seat 21 to fix the cover 27, the outer guide member 26 and the inner guide member 24 on the sealing disk 215 of the valve seat 21.

The inner guide member 24 is mounted in the annular wall 216 of the valve seat 21 and has a periphery formed with a plurality of oblique guide slots 244 connected to the inner water outlet holes 218 of the valve seat 21 and the inner water injection holes 274 of the cover 27. The inner guide member 24 has a first side 242 which defines a water inlet space “a” between the inner guide member 24 and the sealing disk 215 of the valve seat 21 to guide a water flow from the inner water outlet holes 218 of the valve seat 21 into the oblique guide slots 244 of the inner guide member 24. The inner guide member 24 has a central portion formed with a through hole 241 mounted on the threaded post 217 of the valve seat 21. The inner guide member 24 has a recessed second side 243 which defines a water outlet space “c” between the inner guide member 24 and the cover 27 to guide a water flow from the oblique guide slots 244 of the inner guide member 24 into the inner water injection holes 274 of the cover 27.

The rotation member 25 is rotatably mounted on the second side 243 of the inner guide member 24 and has a periphery provided with a plurality of blades 252 aligning with the oblique guide slots 244 of the inner guide member 24 so that the rotation member 25 is rotated by a water flow from the oblique guide slots 244 of the inner guide member 24. One of the blades 252 of the rotation member 25 is provided with a catch portion 253 which in turn produces a water catch effect to each of the oblique guide slots 244 of the inner guide member 24 during rotation of the rotation member 25 so that each of the oblique guide slots 244 of the inner guide member 24 produces an intermittent water injection action. The rotation member 25 has a central portion formed with a shaft hole 251 rotatably mounted on the threaded post 217 of the valve seat 21.

The outer guide member 26 is mounted between the sealing disk 215 of the valve seat 21 and the cover 27 and has a periphery provide with a plurality of water injection posts 262 each connected to the outer water outlet holes 219 of the valve seat 21 and each extended through a respective one of the outer water injection holes 276 of the cover 27 to inject a water flow from the outer water outlet holes 219 of the valve seat 21. The outer guide member 26 has a recessed inner side which defines a water space “b” between the outer guide member 26 and the sealing disk 215 of the valve seat 21 to guide a water flow from the outer water outlet holes 219 of the valve seat 21 into the water injection posts 262 of the outer guide member 26. The outer guide member 26 has a central portion formed with a mounting hole 261 mounted on the annular wall 216 of the valve seat 21.

In operation referring to FIGS. 1-5, when the adjusting ring 23 is rotated to the position as shown in FIG. 5, the two distal ends of the valve shaft 22 are rested on two opposite second positioning points 233 of the adjusting ring 23 respectively, so that the sealing ring 223 of the valve shaft 22 is located at the middle position of the valve chamber 211 of the valve seat 21 and the inner water outlet holes 218 and the outer water outlet holes 219 of the valve seat 21 are connected to the water chambers 222 of the valve shaft 22 respectively. Thus, the water from the valve chamber 211 of the valve seat 21 in turn flows through the water chambers 222 of the valve shaft 22, the inner water outlet holes 218 and the outer water outlet holes 219 of the valve seat 21 into the water inlet space “a” and the water space “b” respectively.

Then, the water from the water inlet space “a” in turn flows through the oblique guide slots 244 of the inner guide member 24, the rotation member 25 and the water outlet space “c” and is injected outward from the inner water injection holes 274 of the cover 27. At this time, the catch portion 253 of one of the blades 252 of the rotation member 25 produces a water catch effect to each of the oblique guide slots 244 of the inner guide member 24 during rotation of the rotation member 25 so that each of the oblique guide slots 244 of the inner guide member 24 produces an intermittent water injection action to provide a massaging effect to a user. At the same time, the water from the water space “b” is directly injected outward from the water injection posts 262 of the outer guide member 26 and the outer water injection holes 276 of the cover 27. Thus, the water is injected outward from the inner water outlet zone 273 and the outer water outlet zone 275 simultaneously to form a combined water injection effect.

Alternatively, when the adjusting ring 23 is rotated to the position as shown in FIG. 6, the first distal end of the valve shaft 22 is rested on one of the first positioning points 232 of the adjusting ring 23 and the second distal end of the valve shaft 22 is rested on the respective opposite third positioning point 234 of the adjusting ring 23, so that the sealing ring 223 of the valve shaft 22 is displaced rightward, the outer water outlet holes 219 of the valve seat 21 are connected to the water chambers 222 of the valve shaft 22, and the inner water outlet holes 218 of the valve seat 21 are sealed by the first stop ring 224, thereby interrupting the connection between the inner water outlet holes 218 of the valve seat 21 and the water chambers 222 of the valve shaft 22. Thus, the water from the valve chamber 211 of the valve seat 21 in turn flows through the water chambers 222 of the valve shaft 22 and the outer water outlet holes 219 of the valve seat 21 into the water space “b” and is directly injected outward from the water injection posts 262 of the outer guide member 26 and the outer water injection holes 276 of the cover 27. Thus, the water is injected outward from the outer water outlet zone 275 to form an outer water injection effect.

Alternatively, when the adjusting ring 23 is rotated to the position as shown in FIG. 7, the first distal end of the valve shaft 22 is rested on one of the third positioning points 234 of the adjusting ring 23 and the second distal end of the valve shaft 22 is rested on the respective opposite first positioning point 232 of the adjusting ring 23, so that the sealing ring 223 of the valve shaft 22 is displaced leftward, the inner water outlet holes 218 of the valve seat 21 are connected to the water chambers 222 of the valve shaft 22, and the outer water outlet holes 219 of the valve seat 21 are sealed by the second stop ring 2240, thereby interrupting the connection between the outer water outlet holes 219 of the valve seat 21 and the water chambers 222 of the valve shaft 22. Thus, the water from the valve chamber 211 of the valve seat 21 in turn flows through the water chambers 222 of the valve shaft 22 and the inner water outlet holes 218 of the valve seat 21 into the water inlet space “a” and then flows through the oblique guide slots 244 of the inner guide member 24, the rotation member 25 and the water outlet space “c” and is injected outward from the inner water injection holes 274 of the cover 27. Thus, the water is injected outward from the inner water outlet zone 273 to form an inner water injection effect.

Accordingly, the shower head assembly forms an inner water injection effect, an outer water injection effect and a combined water injection effect so that the shower head assembly has different water injection modes so as to satisfy the requirements of different users. In addition, the catch portion 253 of one of the blades 252 of the rotation member 25 produces a water catch effect to each of the oblique guide slots 244 of the inner guide member 24 during rotation of the rotation member 25 so that each of the oblique guide slots 244 of the inner guide member 24 produces an intermittent water injection action to provide a massaging effect to a user. Further, the handle 10 has an anti-slip effect so as to facilitate a user holding the handle 10.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A shower head assembly, comprising:
a handle having a hard body made of plastic material integrally formed by an injection molding process, and a soft coating layer integrally coated on the hard body and having a thickness of about 1.5 to 4.5 mm so that the handle has an anti-slip effect.

2. The shower head assembly in accordance with claim 1, wherein the hard body has a surface formed with a plurality of hard layers protruded from the soft coating layer and arranged in a staggered manner, and each of the hard layers the hard body has a thickness equal to that of the soft coating layer.

3. A shower head assembly, comprising a mode control device including:
a valve seat having a mediate portion formed with a valve chamber and having a first end provided with a sealing disk having a side formed with an annular wall, a plurality of inner water outlet holes located inside of the annular wall and connected to the valve chamber and a plurality of outer water outlet holes located outside of the annular wall and connected to the valve chamber;
a valve shaft movably mounted in the valve chamber of the valve seat and having two distal ends each protruding outward from the valve seat, the valve shaft having a mediate portion formed with two spaced annular grooves which define two water chambers between the valve shaft and the valve chamber of the valve seat;
a first stop ring mounted on the valve shaft to move therewith and movable to seal the inner water outlet holes of the valve seat to close a connection between the inner water outlet holes of the valve seat and the water chambers of the valve shaft;
a second stop ring mounted on the valve shaft to move therewith and movable to seal the outer water outlet holes of the valve seat to close a connection between the outer water outlet holes of the valve seat and the water chambers of the valve shaft;
an adjusting ring rotatably mounted on the valve seat and having an inner wall formed with a cam portion rested on the two distal ends of the valve shaft to move the valve shaft in the valve chamber of the valve seat by rotation of the adjusting ring;
a cover mounted on the sealing disk of the valve seat and having an inner water outlet zone formed with a plurality of inner water injection holes connected to the inner water outlet holes of the valve seat and an outer water outlet zone formed with a plurality of outer water injection holes connected to the outer water outlet holes of the valve seat.

4. The shower head assembly in accordance with claim 3, wherein the cam portion of the adjusting ring has a plurality of first positioning points, second positioning points and third positioning points, wherein any two of the second positioning points are located opposite to each other to press the two distal ends of the valve shaft, and each of the first positioning points is located opposite to a respective one of the third positioning points to press the two distal ends of the valve shaft.

5. The shower head assembly in accordance with claim 4, wherein when the two distal ends of the valve shaft are rested on two opposite second positioning points of the adjusting ring respectively, the inner water outlet holes and the outer water outlet holes of the valve seat are connected to the water chambers of the valve shaft respectively.

6. The shower head assembly in accordance with claim 4, wherein when a first distal end of the valve shaft is rested on one of the first positioning points of the adjusting ring and a second distal end of the valve shaft is rested on the respective opposite third positioning point of the adjusting ring, the outer water outlet holes of the valve seat are connected to the water chambers of the valve shaft, and the inner water outlet holes of the valve seat are sealed by the first stop ring, thereby interrupting the connection between the inner water outlet holes of the valve seat and the water chambers of the valve shaft.

7. The shower head assembly in accordance with claim 6, wherein when the first distal end of the valve shaft is rested on one of the third positioning points of the adjusting ring and the second distal end of the valve shaft is rested on the respective opposite first positioning point of the adjusting ring, the inner water outlet holes of the valve seat are connected to the water chambers of the valve shaft, and the outer water outlet holes of the valve seat are sealed by the second stop ring, thereby interrupting the connection between the outer water outlet holes of the valve seat and the water chambers of the valve shaft.

8. The shower head assembly in accordance with claim 3, wherein the mode control device further includes an inner guide member mounted in the annular wall of the valve seat and having a periphery formed with a plurality of oblique guide slots connected to the inner water outlet holes of the valve seat and the inner water injection holes of the cover.

9. The shower head assembly in accordance with claim 8, wherein the inner guide member has a first side which defines a water inlet space between the inner guide member and the sealing disk of the valve seat to guide a water flow from the inner water outlet holes of the valve seat into the oblique guide slots of the inner guide member.

10. The shower head assembly in accordance with claim 9, wherein the inner guide member has a recessed second side which defines a water outlet space between the inner guide member and the cover to guide a water flow from the oblique guide slots of the inner guide member into the inner water injection holes of the cover.

11. The shower head assembly in accordance with claim 9, wherein the mode control device further includes a rotation member rotatably mounted on a second side of the inner guide member and having a periphery provided with a plurality of blades aligning with the oblique guide slots of the inner guide member so that the rotation member is rotated by a water flow from the oblique guide slots of the inner guide member.

12. The shower head assembly in accordance with claim 11, wherein one of the blades of the rotation member is provided with a catch portion which in turn produces a water catch effect to each of the oblique guide slots of the inner guide member during rotation of the rotation member so that each of the oblique guide slots of the inner guide member produces an intermittent water injection action.

13. The shower head assembly in accordance with claim 3, wherein the mode control device further includes an outer guide member mounted between the sealing disk of the valve seat and the cover and having a periphery provide with a plurality of water injection posts each connected to the outer water outlet holes of the valve seat and each extended through a respective one of the outer water injection holes of the cover to inject a water flow from the outer water outlet holes of the valve seat.

14. The shower head assembly in accordance with claim 13, wherein the outer guide member has a recessed inner side which defines a water space between the outer guide member and the sealing disk of the valve seat to guide a water flow from the outer water outlet holes of the valve seat into the water injection posts of the outer guide member.

15. The shower head assembly in accordance with claim 3, wherein the sealing disk of the valve seat has a central portion provided with a threaded post, the cover has a central portion formed with a through hole, and the mode control device further includes a locking bolt extended through the through hole of the cover and screwed into the threaded post of the valve seat to fix the cover on the sealing disk of the valve seat.

16. The shower head assembly in accordance with claim 3, wherein the mediate portion of the valve shaft is provided with at least one sealing ring to separate and seal the two water chambers.

17. The shower head assembly in accordance with claim 3, further comprising a handle mounted on the mode control device and having an inside formed with a flow channel having a first end formed with a water inlet and a second end formed with a water outlet, wherein the water outlet of the handle has an inner peripheral wall having an inner face formed with an inner thread and an end face formed with a plurality of ratchet teeth, the valve seat has a second end provided with a connector mounted in the inner peripheral wall of the water outlet of the handle and connected to the valve chamber, and the connector of the valve seat has an outer wall engaged with the ratchet teeth of the water outlet of the handle and formed with an outer thread screwed into the inner thread of the water outlet of the handle.

18. The shower head assembly in accordance with claim 17, wherein the handle has a hard body made of plastic material integrally formed by an injection molding process, and a soft coating layer integrally coated on the hard body and having a thickness of about 1.5 to 4.5 mm so that the handle has an anti-slip effect.

19. The shower head assembly in accordance with claim 17, wherein the water outlet of the handle has an outer peripheral wall separated from the inner peripheral wall, and the adjusting ring is located between the outer peripheral wall of the water outlet of the handle and the sealing disk of the valve seat.

20. The shower head assembly in accordance with claim 17, further comprising an O-ring mounted between the connector of the valve seat and the inner peripheral wall of the water outlet of the handle.
